(19) United States
(12) Patent Application Publication
(10) Pub. No.: US 2005/0131781 A1
(43) Pub. Date: Jun. 16, 2005

(54) SYSTEM AND METHOD FOR AUDITING

(75) Inventors: Barbara Ann Benson, Plymouth, MI (US); David Norbert Smart, Billericay Essex (GB); Jonathan Michael Rock, Plymouth, MI (US); Kurt Kevin Kappel, Batavia, IL (US); Linda Susan Scibilia, Ann Arbor, MI (US); Mark Steven Henry, Livonia, MI (US); Melissa Ann Hudson-Nowak, Temperance, MI (US); Robert Pawelski, Plymouth, MI (US); Simon Thomas Humberstone, Essex (GB); Silvano Stefano Parducci, West Bloomfield, MI (US); Theresa Louise Blanchard, Bucyrus, OH (US); Michael Powaser, Dearborn, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 10/707,387

(22) Filed: Dec. 10, 2003

(51) Int. Cl. G06F 17/60

(52) U.S. Cl. 705/30

(57) ABSTRACT

A Computer-implemented system and method for auditing that allows an auditor to comment on responses made by an audited entity. The comments are classified according to the subject matter and content of the comment for use in processing and monitoring correction of the comment.

### BACKGROUND OF INVENTION

1. Field of the Invention

The present invention relates to auditing. In particular, one aspect of the present invention relates to computer-implemented systems and methods for auditing that allow the auditor to comment on responses made by an audited entity.

2. Background Art

Auditing relates the examination of an entity for the purposes of assessing the entity's abilities and capabilities with respect to a number of aspects of the entity's work. For example, audits can focus on the entity's accounts, business structures, information technologies, manufacturing facilities, etc.

To facilitate the examination and to make sure the auditor is focusing on the desired aspects of the entity's work, the auditor can be provided with a predefined set of audit questions. The audit questions can cover any aspect of the entity's work and can be in the form of a direct question to the entity or a request for the auditor to review data or request specific pieces of data. Each question includes a predefined answer for characterizing the entity's response to the question, such as yes, no, or not applicable answers. Depending on the type of question and the substance of the response, the auditor may need or want to expand beyond the provided answers. If the auditor would like to expand beyond the provided answers, the auditor can provide additional information and data, whether positive or negative, by adding a comment to the audit question.

When the auditor includes the comment to supplement the provided answers, the auditor is said to be commenting on the question and the added data is said to be the comment. While the comments are helpful to further define the responses, the comments are usually the auditor's own subjective words. With a number of different auditors conducting audits and a number of different areas being audited, the number of comments that a general auditing office may need to monitor and analyze can be rather large. The subjectivity of each comment makes it even more difficult for the general auditor's office to monitor and analyze the comments.

### SUMMARY OF INVENTION

One aspect of the present invention overcomes the above-identified deficiencies by providing an auditor with an ability to classify comments according to selectable classifications.

One aspect of the present invention relates to a system for auditing. The system comprises an audit survey module configured to display at least one audit survey and a number of audit questions for the audit survey. In addition, the system comprises a comment module configured to receive a comment and at least one selection from a number of selectable classifications provided by the comment module for describing the comment. The comment module is used for classifying an answer to one of the audit questions according to the selected classification.

Another aspect of the present invention relates to a computer-implemented method for auditing. The computer-implemented method for auditing comprises providing a number of selectable classifications for describing a comment and receiving at least one selection from the number of selectable classifications for describing the comment. In addition, the comment and the at least one selected classification is transmitted to a computer-readable medium for auditing.

Yet another aspect of the present invention relates to a web-based method for conducting and monitoring a number of audits. The web-based system includes providing a computer-readable medium that is accessible through a web page. From the computer-readable medium, an audit survey module and an audit comment module are downloaded. The audit survey module is configured to display at least one audit survey and a number of audit questions for the audit survey. The audit comment module is configured to provide a comment entry field for entering in a textual description of a comment to one of the audit questions and it is also configured to provide a number of selectable classifications for describing the textual description of the comment. After downloading the audit survey module and the audit comment module, an auditor enters the textual description and selects at least one of the selectable classifications. Once each audit survey questions is asked and any comments to the questioned are entered, the auditor uploads the audit survey module and the comment module to the computer-readable medium.

### BRIEF DESCRIPTION OF DRAWINGS

FIG. 1 illustrates a system for auditing, in accordance with the present invention;

FIG. 2 illustrates a survey module, in accordance with the present invention;

FIG. 3 illustrates a comment module, in accordance with the present invention;

FIG. 4 illustrates a completed audit module, in accordance with the present invention;

FIG. 5 illustrates a graphical display module, in accordance with the present invention;

FIG. 6 illustrates a comment solutions module, in accordance with the present invention;

FIG. 7 illustrates a comment correction module, in accordance with the present invention;

FIG. 8 illustrates an audit review module, in accordance with the present invention; and

FIG. 9 illustrates an audit assessment module, in accordance with the present invention.

### DETAILED DESCRIPTION

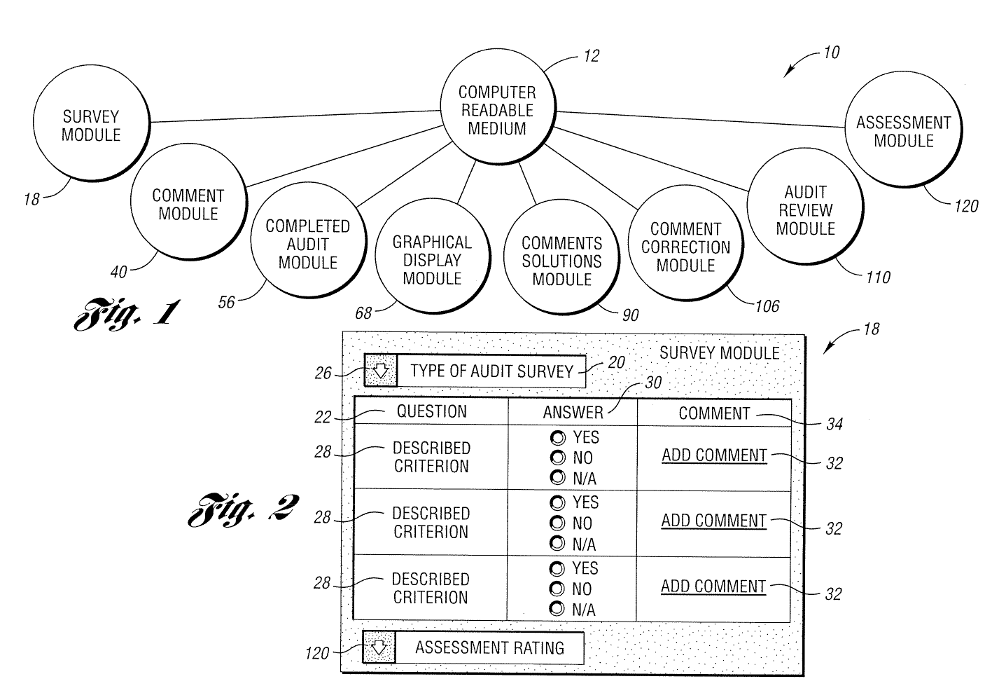

FIG. 1 illustrates a system 10 for auditing according to one aspect of the present invention. The system 10 includes a computer-readable medium 12 for communicating with a number of modules that perform different aspects related to auditing. The computer-readable medium 12 can be any computer-readable medium that is capable of executing software commands and protocols, like a microprocessor, a computer, a server, or other database.

The modules comprise downloadable, computer-readable files or web-based mediums for accessing data stored on the computer-readable medium. The system 10 can be used with any auditing procedure for auditing any type of organization or individual. The system 10 can be configured to create one seamless audit procedure, from audit engagement to final correction of identified process weaknesses for improving the efficiency and effectiveness of audit work and enhancing communication with customers to improve the corporate control environment.

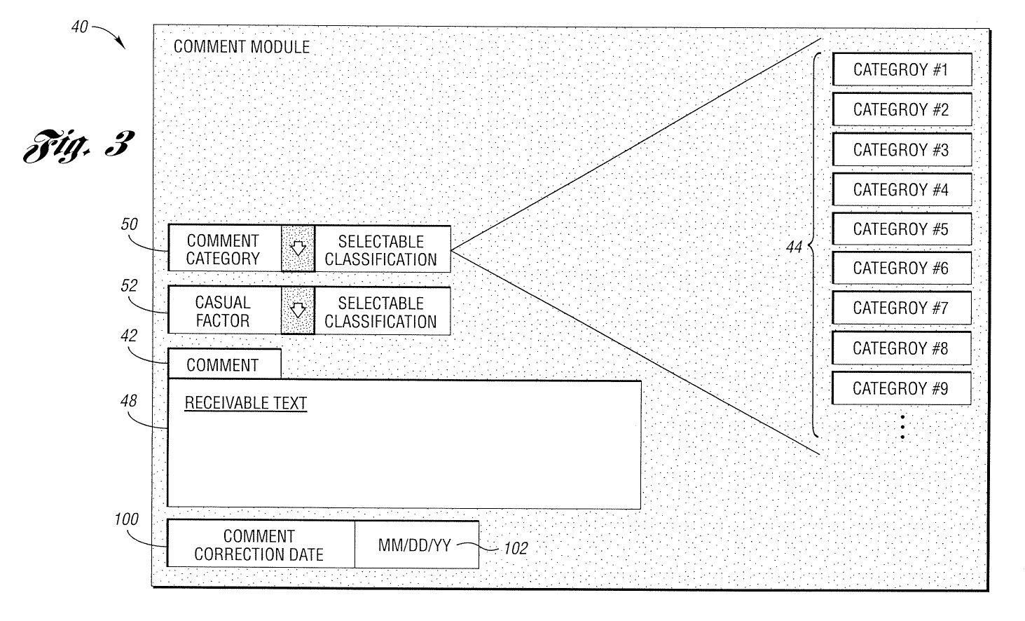

One aspect of the present invention relates to providing auditors with audit surveys for assistance with conducting the audit. Accordingly, as shown in FIG. 2, an audit survey module 18 is provided. The audit survey module 18 can be configured to display one or more audit surveys 20. Each audit survey 20 includes a number of audit questions 22 for the audit survey 20 that relate to aspects of the audited entity's work. The desired type of audit survey 20 can be selected from a drop-down menu 26. Based on the selected audit survey 20, the audit module 18 accesses the computer-readable medium 12 to retrieve the selected audit 20. The selected audit survey 20 includes described criterion 28 for each audit question 22. The auditor should review the subject matter of the audited entity's work that corresponds with the described criterion 28 and record a response in the provided answer section 30.

The auditor can access the audit survey 20 through a web-based medium or download the audit survey 20 as an audit file that can be displayed on a laptop computer. If the auditor downloads the audit survey 20 to a laptop computer, the auditor can take the laptop to the site of the audit and ask the displayed questions and record the response on the laptop. When completed, the auditor can upload the downloaded audit survey module 18 back to the computer-readable medium 12. If the auditor is working through a web-based medium, like a web page, the auditor can display the audit questions 22 as if the audit survey 20 were downloaded to the laptop, but instead of having to upload the completed audit survey 20, the responses to the audit questions are automatically recorded on the computer-readable medium 12.

The audit survey 20 questions can be displayed in any type of format. As shown, the text of the questions are in one column with a corresponding answer section 30 to record the audited entity's response to the question. The responses to the questions are recorded by selecting one of the radio buttons that correspond with yes, no, or not applicable. In most cases, the text of the question sets up the answer to the questions in such a manner that, when the answer is read in combination with the questions, the yes, no, or not applicable response is sufficient to examine and analyzing the aspect of the entity's work that the question pertains to. If the auditor would like to add supplemental information beyond the provide responses, the auditor can click on an add comment link 32 provided in a comment section 34. The add comment link 32 connects the auditor to or otherwise displays a comment module 40 for receiving the supplemental information.

The comment module 40, as shown in FIG. 3, is configured to receive a comment 42 and at least one selection from a number of selectable classifications 44 provided by the comment module for describing the comment. The selectable classifications 44 are standardized so that the subjective comments 42 of the auditor can be associated according to predefined identities for use with storing, retrieving, monitoring, and analyzing the comments 42. In this manner, the present invention can be configured for to provide one seamless audit procedure, from audit engagement to final correction of identified process weaknesses, for improving the efficiency and effectiveness of audit work and enhancing communication with customers to improve the corporate control environment.

The comment module 40 is displayed by clicking on the comment link 32 provided for each question in the audit survey module 18, but the comment module 40 could be displayed in any other manner. As such, the comment module 40 is typically accessed in the same manner that the audit survey module 18 is accessed, i.e., through a web page or a downloaded file. Likewise, the comment module 40 could be standalone module that can be uploaded and download with or without the audit survey module 18.

The comment module 40 provides a comment field 48 and two separate and selectable classification menus 50, 52. By selecting one of the selectable classifications 44 provided for each menu 50 and 52, the comment 42 is classified according to predefined classification. By simply reviewing the top-down description provided by the classifications 44, the general thoughts contained in the comment 42 for the supplemental data is known.

The comment field 48 is a positional location provided by the comment module for directing the auditor where to type in the details (text) of the comment 42. The comment 42 relates to a textual description entered by the auditor to describe a process strength, a process weakness, or other information of the audited entity with respect to one of the audit questions 22.

The classifications 44 used for classifying the comments 42 can include any number of different classifications 44, including a number of classifications that can be selected from the group consisting of a number of comment categories and a number of causal factors. The comment categories can be used to describe a broad process to which the comment question relates to and the causal factors can be used to describe why there is a strength or weakness for the broad process of the comment category. The selected comment category and causal factor classifications 44 provide a two-tiered system for classifying a comment 42 that comprises a general description of the subject matter of the comment and a general description of why there is a comment 42. This provides a standardized system for describing each comment by associating at least one comment classification 44 with each comment 42 for use in classifying and commenting on an answer to one of the audit questions 22.

As shown, the drop-down classification menus 50 and 52 correspond with comment categories and the causal factors that are accessed through the drop-down menu, but other arrangements can be used. For example, each comment category or causal factor could be provided on the screen with a radio button next to each classification for selecting the desired classification. Still further, the comment module 40 could be provided with a restricted classification field that would restrict, or only accept, entries that correspond with a predefined list of comment categories and causal factors.

Once the classifications are selected and the details of the comment 42 are received in the comment field, the auditor closes the comment 42 for attachment and association with the audit survey 20 question that prompted the comment 42. As the auditor progresses through the audit and asks more and more audit questions, the auditor may desire to enter a comment 42 to other questions 22. The auditor can add a comment 42 for each question 22 by simply clicking on the comment link 32 provided for each question 22. The comment module 40 attaches and associates each comment 42 to the question 22 that prompted the comment 42. A number of comments 42 can be entered, along with the selected classifications 44, for any number of questions 22. In addition, while not shown, multiple comments 42 could be entered for some questions 22 by clicking a double-comment button in the comment module or by providing another add comment link in the survey module.

Once each question is asked and the relevant comments are received, the audit is complete. Upon completion, the audit survey module 18 can transmit or otherwise send the answers to each question 22 and the attached comments 42 to the computer-readable medium 12. If the audit survey 20 was downloaded to laptop, this is accomplished through an uploading step. If the audit survey 20 was accessed through a web page, the completed audit survey is already transmitted to the computer-readable medium. The transmitted information then becomes data stored on the computer-readable medium 12 that can be accessed and analyzed for monitoring the audited entity.

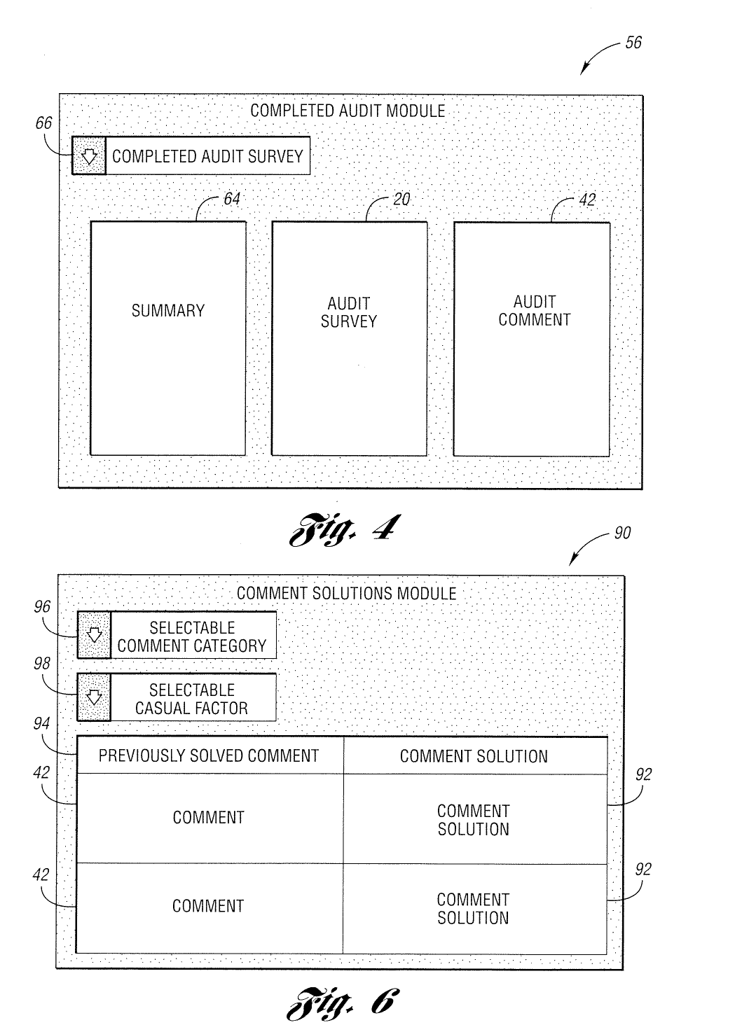

The completed audit surveys 20 and corresponding comments 42 are accessed with a completed audit module 56, as shown in FIG. 4. The completed audit module 56 can be configured with a completed audit menu 66 for selecting a completed audit. Based on the selected audit, the completed audit module 56 can display a summary report 64, the audit survey 20, and the comments 42 for the completed audit. The completed audit module 56 can be a downloadable file or a web page. The completed audit module 56 can be configured for determining or receiving an identification of the audited entity for determining the audits available under the completed audit menu 66. The audited entity can be identified in a log-in procedure, or other procedure, so that the drop-down menu only displays audit surveys for the identified entity.

The audit summary 64 is a document prepared by the auditor after completion of the audit and uploaded with the completed audit survey 20 and the comments 42 to the computer-readable medium 12. The auditor can download or access through a web page a word processing template for use in filling out the summary report. The template can provide a number of headings for entering specified information for summarizing the completed audit. Optionally, the survey module 18 can be used to provide the template. The summary is sometimes referred to as an executive summary. The audit survey 20 and the audit comments 42 can be separately downloadable from the completed audit module 56. In addition, as multiple audit surveys 20 can be conducted in one audit, more than one audit survey 20 and comments 42 can be displayed.

One aspect of the present invention relates to providing information in a meaningful manner so the results from a completed audit can be examined and understood without having to review the subjective content of each comment. Accordingly, as shown in FIG. 5, a graphical display module 68 is provided. The graphical display module 68 is configured to graphically display a classification selection frequency 70 for at least one of the selectable classifications 44.

A graph 72 displays the selection frequency 70 in response to selecting at least one of the selectable classification 44, that are now shown as comment categories 16 and causal factors 78, and a submit button 74. The graph 72 is a numeric representation of the number of times each selected comment category 76 and causal factor 78 have occurred in completed audits. This type of display can be generated by the computer-readable medium calculating the classification selection frequency for one or more of the selectable classifications and displaying the classifications selection frequency with the graphical display module. In addition, predefined graphs can be accessed by selecting a recurring comment categories link 80 or a recurring causal factors link 82 for displaying the classification selection frequency for the top five recurring comment categories or the top five recurring causal factors for an audited entity over a selectable period of time 84. These and other graphs can be generated based on the comment categories and causal factors to generally describe the comments in a numerical manner so that each comment does not have to be reviewed in order to understand the aspects of the entity's work that are strengths or weaknesses. The graph 72 can be limited to an identified entity and only the selection frequency 70 for the identified entity is calculated.

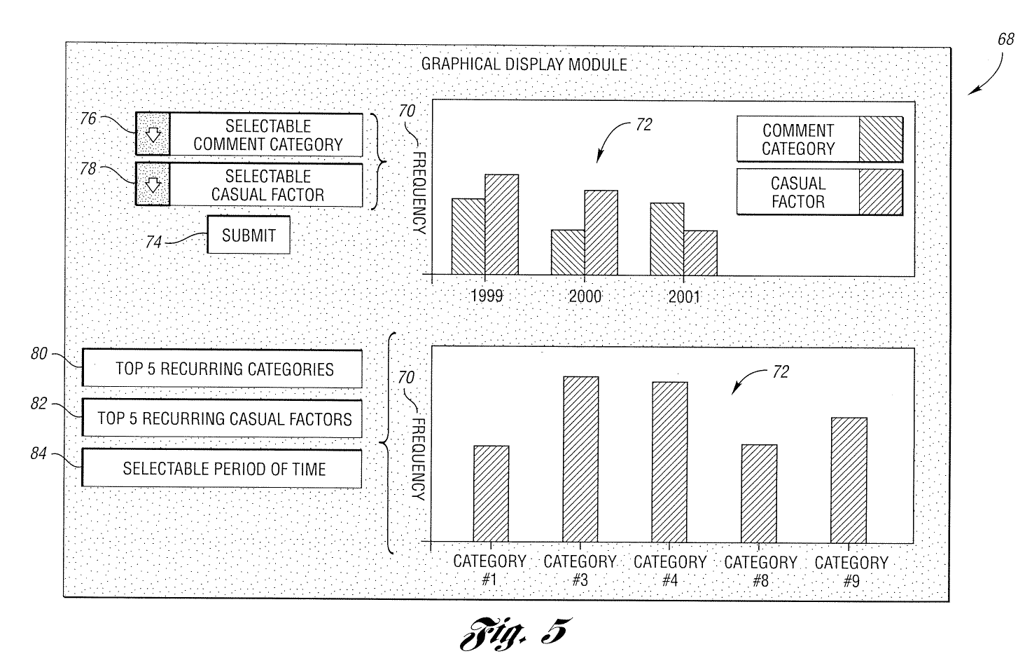

As many of the comments relate to weaknesses in the audited entity's processes, the auditor can require the audited entity to correct or solve the weakness as identified in the comment. Accordingly, as shown in FIG. 6, a comment solutions module 90 is provided for displaying comment solutions 92 for previously solved comments 94. The comment solutions 92 are retrievable by searching the computer-readable database based on at least one of the selectable classifications 44, shown as a comment category menu 96 and a comment causal factor menu 98.

An audited entity can select at least one of the comment categories 96 or causal factors 98 for accessing previously solved comments that correspond with the select comment categories 96 and causal factors 98. By leveraging off the comment solutions 92, the audited entity can develop a process for correcting the comment 42 that has had success in the past. For example, if the audited entity receives a comment classified according to a comment category for asset integrity and a causal factor for insufficient system capabilities, the audited entity can search through the comment solutions module to find other comments that fall under the same combination of classifications. The audit entity can then review the other comments described for the same classification headings and see the comment solution so that the audited entity may obtain additional information for solving or correcting the comment.

In addition to providing comment solutions to assist the audited entity in correcting comments, another aspect of the present invention relates to monitoring the progress of the audited entity in correcting the comment 42. Accordingly, one aspect of the present invention comprises further configuring the comment module 40 to provide a date field 100 for receiving a comment correction date 102. The comment correction date 102 is entered by either the auditor or the audited entity to indicate when the audited entity is expected to correct the comment 42. The comment correction date 102 can be entered by typing in the calendar date or the comment module 40 could provide a menu or other means for receiving the date.

Based on the comment correction completion date 102, the auditor and the audited party have an idea of a time frame in which any problems that need to be corrected for the described comment 42 are expected to be completed. The auditor can enter the comment correction date 102 at the time to the comment 42 is entered so that the comment correction date 102 can be transmitted to the computer-readable medium with the audit survey and the comments, or the audited entity can access the comment through a comment corrective action module 106.

The comment corrective action module 106, as shown in FIG. 7, uses the original comment correction date 102 for monitoring comment correction. The corrective action module 106 is accessed by the auditor or the identified entity based on the entity's identification so that only the comment 42 for the identified entity are shown. The comment corrective action module 106 is designed to permit monitoring of the audited entity's progress in correcting the comment by obtaining an evaluation rating 108 for monitoring the audited entity's progress in correcting the comment.

The evaluation rating 108 is obtained based on a difference between the original comment correction completion date 102 and an updated comment correction completion 110 date received by the comment correction module 106. The updated comment corrective action date 110 is usually entered by either the auditor or the audited party typing the date directly into the comment through the corrective action module 106, but it could also be entered with a drop-down menu. Each quarter the audited entity should submit and update the outstanding comments so that the evaluation rating 108 can be updated.

If the updated comment correction completion date 110 is changed to a date that occurs after the originally inputted comment correction completion date 102, the corrective action module 106 determines a yellow calculation rating 108. The yellow rating means the audited entity is not on target for correcting the comment as originally planned. The yellow rating is also determined if the original comment correction completion date 102 is entered for a period that occurred more than six months after the close of the audit. If the updated comment correction completion date 110 is the same or earlier than the originally entered comment correction date 110, the evaluation rating 108 is green. The green rating means the audited entity is on target for correcting the comment as originally planned. If the evaluation rating 108 is yellow based on the updated comment correction date 110, the evaluation rating 108 can become green if the updated corrective action date 110 is changed back to a date that is the same as or earlier than the originally entered comment correction date 102. Alternatively, if another updated comment correction date 110 is entered after the previously updated comment correction date 110 and the subsequently updated date 110 is later than the previously entered updated date 110, the evaluations rating 108 is determined to be red. The red rating means the audited entity is falling even farther behind in correcting the comment. The red rating is also determined if the original comment correcting completion date 102 is not entered at a predetermined time after the audit is closed.

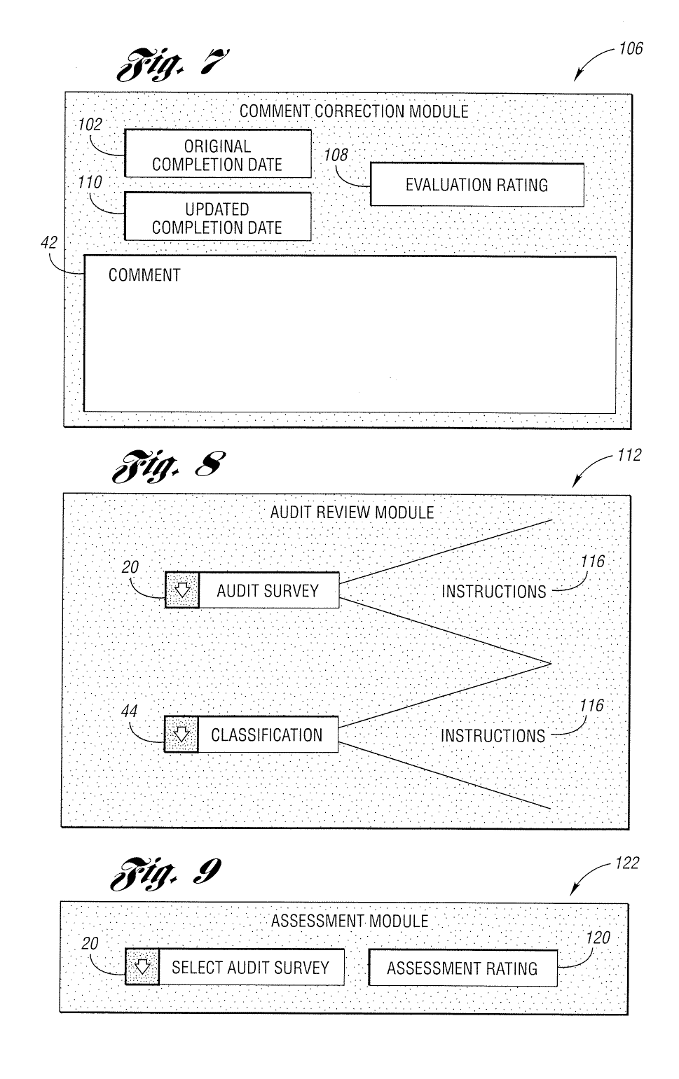

As described above, the selectable classifications 44 can include any number of different descriptions. In addition, there are a number of different audit surveys 20 that can be selected for conducting different types of audits. Accordingly, as shown in FIG. 8, an audit review module 112 is configured to display instructions 116 for the selected audit survey 20 and the classification 44.

The instructions 116 for the audit survey 40 detail the content of the audit and how the audit will be conducted. The instructions 116 for the classifications 44 detail criteria for explaining selection protocol for each one of the number of selectable classifications 44. Either the audit survey 20 or the classifications 44 can be selected from a drop-down menu, or other means, for displaying the corresponding instructions 116. A new auditor or the audited entity, can accesses the instructions, which are stored on the computer-readable medium, through the audit review module 112 so that they can prepare themselves for the audit.

Another aspect of the present invention relates to monitoring the overall ratings that an audited entity receives. As shown in FIG. 2, the audit survey module 18 includes a number of selectable assessment ratings 120. The assessment ratings 120 are used to rate the entire audit. If more than one audit survey 20 is displayed by the audit module 18, then the assessment rating 120 relates to the total assessment for all the displayed audit surveys 20. As shown, only one assessment ratings 120 is provided for each audit.

An audit assessment module 122, as shown in FIG. 9, is configured to receive the assessment rating 120 and display the assessment rating 120 for one of the audit surveys 20 by providing a menu for selecting the desired audit survey 20. In the case where multiple audit surveys 20 were downloaded with the audit module 18, as each audit is assigned the assessment rating 122 for the overall audit, only one of the audit surveys 20 needs to be selected in order to display the assessment rating 120 for the entire audit.

While the best mode for carrying out the invention has been described in detail, those familiar with the art to which this invention relates will recognize various alternative designs and embodiments for practicing the invention as defined by the following claims.

1. A system for auditing, the system comprising:
an audit survey module configured to display at least one audit survey and a number of audit questions for the audit survey; and
a comment module configured to receive a comment and at least one selection from a number of selectable classifications provided by the comment module for describing the comment, wherein the comment module is used for classifying an answer to one of the audit questions.

2. The system of claim 1 further comprising a completed audit module configured to display a summary report and comment for each completed audit survey.

3. The system of claim 2 wherein the number of selectable classifications provided by the comment module comprises at least one from the group consisting of a number of comment categories and a number of causal factors.

4. The system of claim 1 further comprising a graphical display module configured to graphically display a classification selection frequency for at least one of the selectable classifications.

5. The system of claim 1 further comprising a comment solutions module configured to display comment solutions and to retrieve each comment solution for display based on at least one of the number of selectable classifications.

6. The system of claim 1 wherein the comment module is further configured to receive a comment correction completion date and wherein the system further comprises a comment corrective action module configured to automatically obtain an evaluation rating for monitoring correction of each received comment based on a difference between the comment correction completion date and an updated comment correction completion date received by the comment corrective action module.

7. The system of claim 1 further comprising an audit review module configured to display instructions for conducting an audit and to display instructions having described criterion for explaining selection protocol for each one of the number of selectable classifications.

8. The system of claim 1 wherein the audit survey module further comprises an number of selectable assessment ratings for rating at least one audit survey and wherein the system further comprises an assessment module configured for selecting at least one audit survey and displaying the assessment rating for the selected audit survey.

9. A computer-implemented method for auditing, the computer-implemented method comprising:
receiving a comment for transmission to a computer-readable medium;
providing a number of selectable classifications for describing the comment;
receiving at least one selection from the number of selectable classification; and
transmitting the comment and the at least one selected classification to the computer-readable medium for auditing.

10. The method of claim 9 further comprising receiving the comment and storing the comment for retrievable based on the at least one selected classification.

11. The method of claim 10 wherein the number of selectable classifications comprises at least one from the group consisting of a number of comment categories and a number of causal factors.

12. The method of claim 9 further comprising providing comment solutions for solved comments and retrieving a comment solution based on at least one of the selectable classifications.

13. The method of claim 9 further comprising receiving a comment correction completion date for transmission with the comment to the computer-readable medium and the computer-readable medium receiving the comment correction completion date and an updated comment correction completion date for automatically obtaining an evaluation rating based on a difference between the original correction completion date and the updated correction completion date, wherein the evaluation is used for monitoring correction of the comment.

14. The method of claim 9 further comprising graphically displaying a classification selection frequency for at least one of the selectable classifications based on a number of received comments.

15. The method of claim 14 further comprising determining a selection frequency for each classification to obtain the top five selected comment categories and graphically displaying the selection frequency for the top five selected comment categories.

16. The method of claim 14 further comprising determining a selection frequency for each classification to obtain the top five selected causal factors and graphically displaying the selection frequency for the top five selected causal factors.

17. A web-based method for conducting and monitoring a number of audits, the web-based system comprising:
providing a computer-readable medium, wherein the computer-readable medium is accessible through a web page;
downloading an audit survey module from the computer-readable medium, the audit survey module configured to display at least one audit survey and a number of audit questions for the audit survey;
downloading an audit comment module from the computer-readable medium, the audit comment module configured to provide a comment entry field for receiving a textual description of a comment to one of the audit questions and the audit comment module further configured to provide a number of selectable classifications for describing the textual description of the comment;
entering the textual description and selecting at least one of the selectable classifications; and
uploading the audit survey module and the comment module to the computer-readable medium.

18. The method of claim 17 further comprising accessing the computer-readable medium through a graphical display module configured to graphically display a classification selection frequency for at least one of the selectable classifications for use in monitoring the audit.

19. The method of claim 17 wherein the comment module is further configured to receive a comment correction completion date and wherein the method further comprises accessing the computer-readable medium through a comment corrective action module configured to automatically obtain an evaluation rating for monitoring correction of each received comment based on a difference between the comment correction completion date and an updated comment correction completion date received by the comment corrective action module.

20. The method of claim 17 wherein the audit survey module further comprises an number of selectable assessment ratings for rating the audit surveys downloaded with the audit survey module and wherein the method further comprises accessing the computer-readable medium through an assessment module configured for selecting at least one audit survey and displaying the assessment rating for the selected audit survey.
